(19) United States
(12) Patent Application Publication
(10) Pub. No.: US 2024/0099338 A1
(43) Pub. Date: Mar. 28, 2024

(54) COOKING OPERATION FOR A COOKING APPLIANCE

(71) Applicant: Electrolux Home Products, Inc., Charlotte, NC (US)

(72) Inventors: Steven Swayne, Nashville, TN (US); Adrienne Nave, Nashville, TN (US); Stanquatia Johnson, Gallatin, TN (US); Desirea Lewis, Lavergne, TN (US); Julia Vesely, Franklin, TN (US)

(21) Appl. No.: 18/368,681

(22) Filed: Sep. 15, 2023

Related U.S. Application Data
(60) Provisional application No. 63/410,864, filed on Sep. 28, 2022.

(51) Int. Cl. A23L 5/10; F24C 7/08

(52) U.S. Cl. CPC A23L 5/15; F24C 7/08

(57) ABSTRACT

A method is provided for cooking a food item in an oven cavity of a cooking appliance, the cooking appliance including a first heating element and a second heating element spaced about the oven cavity. The method includes a first stage wherein the first heating element and the second heating element are sequentially energized according to a first duty cycle in which the first heating element is energized at a first time for a first duration and the second heating element is energized at a second time for a second duration. The first duration and the second duration are regulated based on a measured temperature and a first predetermined target temperature.

### CROSS-REFERENCE TO RELATED APPLICATION

This application claims the benefit of U.S. Provisional Application No. 63/410,864 filed Sep. 28, 2022, the contents of which are hereby incorporated herein by reference.

### TECHNICAL FIELD

The present disclosure relates to a cooking operation for a cooking appliance and, more particularly, to a cooking operation that can simulate rotisserie cooking for a stationary food item.

### BACKGROUND

In conventional rotisserie cooking, a food item is suspended on a skewer, which is rotated by a motor relative to a heat source so that every side of the food item is periodically and evenly exposed to direct radiation from the heat source. However, implementing a rotisserie system within an oven compartment of a domestic cooking appliance can be difficult and expensive, mainly because the motor typically is installed outside of the oven compartment to isolate it from the heat in that compartment. Meanwhile, the skewer is arranged within the compartment and must be coupled to the motor via a rotatable shaft that penetrates the compartment body.

### BRIEF SUMMARY

In accordance with a first aspect, a method is provided for cooking a food item in an oven cavity of a cooking appliance, the cooking appliance including a first heating element and a second heating element spaced about the oven cavity. The method includes a first stage wherein the first heating element and the second heating element are sequentially energized according to a first duty cycle in which the first heating element is energized at a first time for a first duration and the second heating element is energized at a second time for a second duration. The first duration and the second duration are regulated based on a measured temperature and a first predetermined target temperature.

In accordance with a second aspect, a method is provided for cooking a food item in an oven cavity of a cooking appliance, the cooking appliance including a first heating element and a second heating element spaced about the oven cavity. The method includes a first stage in which the first heating element and the second heating element are sequentially energized according to a first duty cycle, wherein operation of the first duty cycle is regulated in order to maintain a measured temperature relative to a first predetermined target temperature. The method further includes a second stage in which the first heating element and the second heating element are sequentially energized according to a second duty cycle until the measured temperature exceeds a second predetermined target temperature that is greater than the first predetermined temperature.

In accordance with a third aspect, a method is provided for cooking a food item in an oven cavity of a cooking appliance, the cooking appliance including a first heating element and a second heating element spaced about the oven cavity. The method includes a first stage in which the first heating element and the second heating element are sequentially energized according to a first duty cycle, wherein operation of the first duty cycle is regulated in order to maintain a measured temperature relative to a first predetermined target temperature. The method further includes a second stage in which the first heating element and the second heating element are sequentially energized according to a second duty cycle until the measured temperature exceeds a second predetermined target temperature that is greater than the first predetermined temperature. The first stage and second stage are repeatedly performed in an alternating manner.

### BRIEF DESCRIPTION OF THE DRAWINGS

FIG. 1 is a schematic side view, in cross-section, of an example cooking appliance;

FIG. 2 shows an example cooking operation for the cooking appliance;

FIG. 3 shows details for an example first stage of the cooking operation;

FIG. 4 shows details for an example second stage of the cooking operation; and

FIG. 5 shows details for an example third stage of the cooking operation.

### DETAILED DESCRIPTION

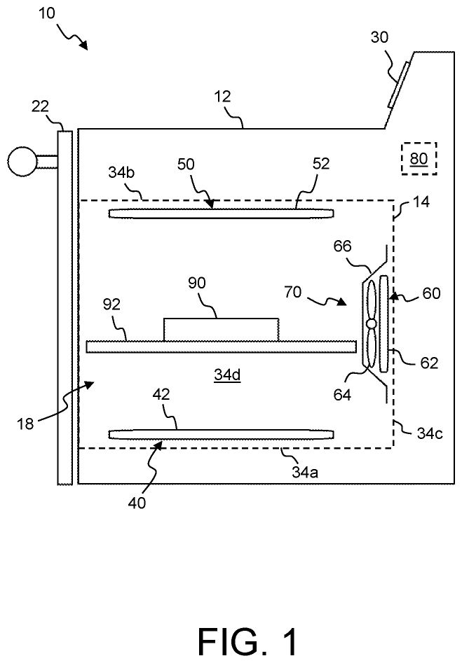

Turning to FIG. 1, an example cooking appliance 10 is illustrated having a housing 12, a cooking compartment 14 within the housing 12 that defines a cavity 18, a door 22 pivotally attached to the housing 12 that provides selective access to the cavity 18, and a control panel having a user interface 30. The compartment 14 has a plurality of walls 34 that define the cavity 18, including a lower wall 34a, an upper wall 34b, a rear wall 34c, a left-side wall 34d, and a right-side wall (not shown) opposite to the left side wall 34d. Moreover, the appliance 10 includes a plurality of heating elements 40, 50, 60 that are spaced about the cavity 18 and can be operated to heat the cavity 18 to perform various cooking operations.

For example, the appliance 10 includes a lower heating element 40 (“bake element”) arranged at or adjacent to the lower wall 34a of the compartment 14, and which can be operated to perform a baking operation. An upper heating element 50 (“broil element”) can be arranged at or adjacent to the upper wall 34b of the compartment 14, and can be operated to perform a broiling operation. And a rear heating element 60 (“convection element”) can be arranged at or adjacent to the rear wall 34c of the compartment 14, and can be operated with a convection fan 64 to perform a convection cooking operation. The rear element 60 (sometimes referred to as a convection element) and the convection fan 64 typically are covered by a protective shroud 66, and collectively form a convection system 70 of the appliance 10.

Each heating element 40, 50, 60 may be an electric-resistive body (e.g., coil) that coverts electrical energy supplied thereto into heat, or a gas burner that burns gas supplied thereto to generate heat. Moreover, each heating element 40, 50, 60 may be located within or outside of the cavity 18, adjacent to its associated compartment wall 34. Still further, the appliance 10 may comprise additional or fewer heating heater elements in other examples. Broadly speaking, the appliance 10 can include any configuration of two or more heating elements spaced about the cavity 18.

The appliance 10 further includes a controller 80 (e.g., programmable logic controller) having a processor and memory, which is operatively coupled (e.g., via one or more wires, relays, digital gas valves, etc.) to the heating elements 40, 50, 60 such that the controller 80 can selectively and independently operate the heating elements 40, 50, 60 to perform various cooking operations. Moreover, the controller 80 is in communication with the user interface 30, which has one or more input elements (e.g., switches, buttons, touchscreens, etc.) that a user can manipulate to provide one or more inputs (e.g., program selections, start commands, temperature settings, etc.) to the controller 80.

Lastly, the appliance 10 includes a temperature sensor 82 that is configured to measure temperature and provide an output to the controller 80 indicative of the measured temperature. The sensor 82 is preferably mounted within the cavity 18 such that the measured temperature directly corresponds to the temperature of air within the cavity 18. Moreover, the appliance 10 may include additional temperature sensors 80 in some embodiments to detect temperature at different locations within the cavity 18 and provide corresponding outputs to the controller 80 indicative of those measured temperatures.

As shown in FIG. 1, a stationary food item 90 can be placed within the cavity 18 and supported by, for example, a stationary rack 92 within the cavity 18, or a stationary skewer mounted to the rack 92 or to one or more walls 34 of the compartment 14. Utilizing the heating elements 40, 50, 60 and temperature sensor 82, the controller 80 may operate the cooking appliance 10 in accordance with one or more cooking operations programmed into the controller 80 to cook the food item 90. In a simple example, a cooking operation could be a baking operation that turns on and regulates the bake element 40 to achieve a desired cavity temperature.

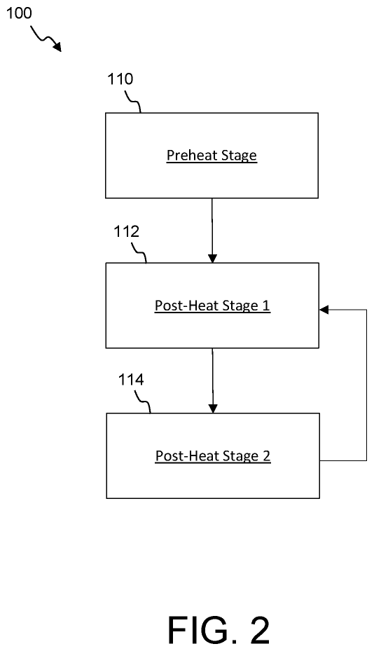

Turning to FIG. 2, an example cooking operation 100 will now be described for cooking the stationary food item 90 in a manner that simulates rotisserie cooking. The cooking operation 100 includes a preheat stage 110, a first post-heat stage 112, and a second post-heat stage 114. Preferably, the stationary food item 90 will be located within the cavity 18 during all three stages 110, 112, 114. However, in other examples, the stationary food item 90 may be kept outside of the cavity 18 during one or more stages such as the first (pre-heat) stage 110.

As discussed further below, each stage 110, 112, 114 comprises operating two or more of the heating elements 40, 50, 60 according to a predetermined duty cycle that sequentially energizes the elements in a particular order, one after another. In the present embodiment, no two elements are active at the same time. However, in other embodiments, sequentially energized heating elements may overlap in being simultaneously active for a period of time, by energizing the next successive heating element before de-energizing the prior-energized heating element in the sequence. The period of overlap may be, for example, 1-10 seconds, 1-8 seconds, 1-5 seconds, or 1-3 seconds. The duty cycle for operating the heating elements is repeatedly performed until an event causes the cycle to stop during the stage. In some examples, one or more parameters of a duty cycle may be adjusted during performance of the duty cycle, as discussed further below.

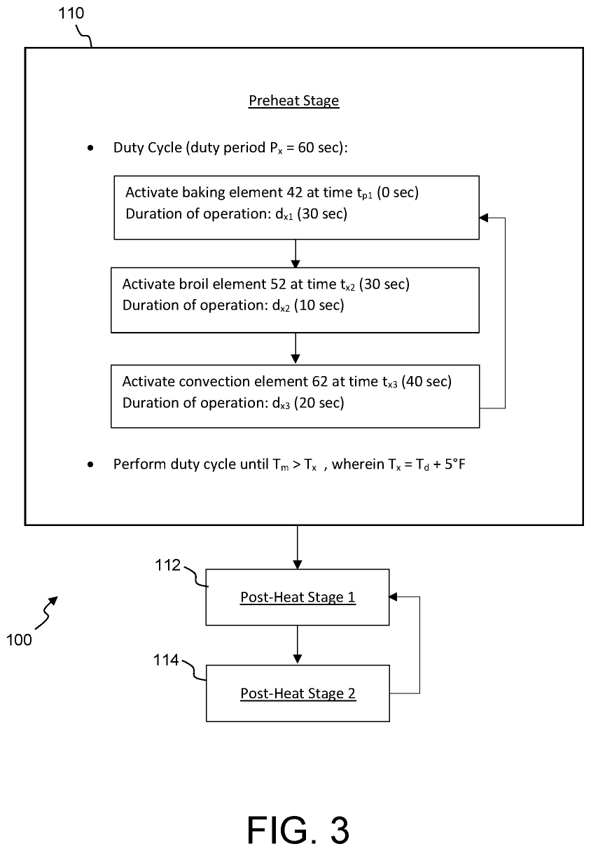

For example, as shown in FIG. 3, the preheat stage 110 has a predetermined duty cycle with a duty period Pₓ, of 60 seconds. In the illustrated embodiment, the preheat duty cycle will energize the bake element 40 at time tₓ₁ (0 seconds) of the duty period Pₓ for a duration dₓ₁ (30 seconds). The duty cycle thereafter will energize the broil element 50 at time tₓ₂ (30 seconds) of the duty period Pₓ, for a duration dₓ₂ (10 seconds). Finally, the first duty cycle will energize the convection element 60 at time tₓ₃ (40 seconds) for a duration dₓ₃ (20 seconds; i.e. the remainder of the duty period PO. During the preheat stage 110 of the present embodiment, only one of the aforementioned heating elements 40, 50, 60 will be energized at a time. The preheat stage 110 will repeatedly perform the duty cycle until the temperature Tₘ measured by the temperature sensor 82 exceeds a target temperature Tₓ of the preheat stage 110, at which point the preheat stage 110 will cease and the first post-heat stage 112 will commence. The transition between the two stages can be effectuated by the controller 80.

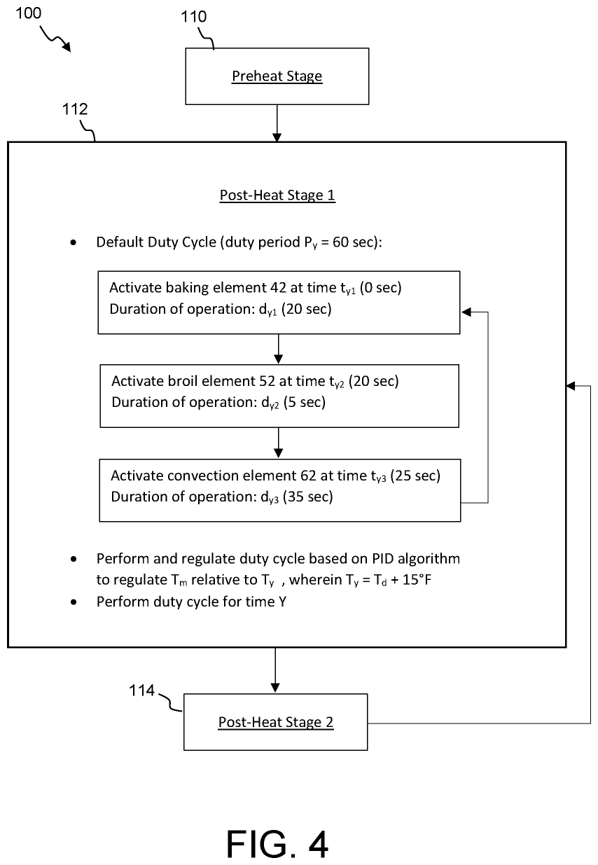

The first post-heat stage 112 has a predetermined duty cycle (see FIG. 4) with a duty period P_{y} of 60 seconds. In the illustrated embodiment, during the first post-heat stage the operative duty cycle will energize the bake element 40 at time t_{y1} (0 seconds) of the duty period P_{y} for a duration d_{y1} (20 seconds). Thereafter it will energize the broil element 50 at time t_{y2} (20 seconds) of the duty period P_{y} for a duration dye (5 seconds). Finally, the duty cycle will energize the convection element 60 at time t_{y3} (25 seconds) of the duty period P_{y} for a duration d_{y3} (35 seconds—i.e. the remainder of the duty period P_{y}). During the first post-heat stage 112 of the present embodiment, only one of the aforementioned heating elements 40, 50, 60 will be energized at a time. These initial settings of the duty cycle are considered its default settings. The first post-heat stage 112 will repeatedly perform its duty cycle while regulating its parameters (and thus operation of the heating elements 40, 50, 60) based on a PID algorithm that compares the measured temperature Tₘ to a predetermined target temperature T_{y} of the first post-heat stage 112.

Specifically, the PID algorithm calculates a gain by comparing, for example, an error between the measured temperature Tₘ and the target temperature T_{y} during the first post-heat stage 112. The error may be determined as a simple relationship between the measured temperature Tₘ and the target temperature T_{y} (e.g., a proportional gain), an accumulated error (e.g., an integral gain), a rate of change of error (e.g., a derivative gain), and/or other similar metrics. During the first post-heat stage 112 the controller 80 will continually recalculate the gain of the PID algorithm and can adjust one or more parameters of the duty cycle based on the calculated gain in order to obtain or maintain a measured temperature Tₘ that is close to the target temperature T_{y}.

For example, during that stage the controller 80 can regulate the durations d_{y1}, d_{y2}, d_{y3} of the duty cycle as a product of their default settings and the gain determined by the PID algorithm. For instance, when the measured temperature Tₘ is significantly less than the target temperature T_{y}, the gain can be 1 and the durations d_{y1}, d_{y2}, d_{y3} will be set to match their default settings. This will enable the duty cycle to more quickly heat the oven cavity 18 and increase the measured temperature Tₘ to achieve the target temperature T_{y} (as compared to a similar duty cycle with shorter durations d_{y1}, d_{y2}, d_{y3}). Conversely, when the measured temperature Tₘ is significantly greater than the target temperature T_{y}, the gain can be 0 and the durations d_{y1}, d_{y2}, d_{y3} will all be set to 0 seconds. This will enable the duty cycle to more quickly reduce the measured temperature Tₘ to achieve the target temperature T_{y} (as compared to a similar duty cycle with positive durations d_{y1}, d_{y2}, d_{y3}).

Meanwhile, when the measured temperature Tₘ is close to the target temperature T_{y}, the gain can be somewhere between 0 and 1 and the durations d_{y1}, d_{y2}, d_{y3} will be set to the product of that gain value and their respective default settings. For example, if the gain is determined to be 0.5, then the durations d_{y1}, d_{y2}, d_{y3} will be respectively set to 10 seconds, 2.5 seconds, and 12.5 seconds based on their respective default settings as set forth above. This can enable the first duty cycle to better maintain the measured temperature Tₘ about the target temperature T_{y} (as compared to a similar duty cycle with longer or shorter durations d_{y1}, d_{y2}, d_{y3}).

During the first post-heat stage 112, the controller 80 can thus regulate the durations d_{y1}, d_{y2}, d_{y3} of the associated duty cycle based on the calculated gain of the PID algorithm to better adjust or maintain the measured temperature Tₘ relative to the target temperature T_{y}. Preferably, once the measured temperature Tₘ reaches the target temperature T_{y}, the first post-heat stage 112 will maintain the measured temperature Tₘ within 15° F. of the target temperature T_{y}, and more preferably within 10° F. of the target temperature T_{y}. That is, the measured temperature Tₘ will fluctuate between peaks of high and low temperatures that are within 15° F. of the target temperature T_{y} or less, preferably for the entire first post-heat stage 112.

However, additional or alternative parameters of the first post-heat stage 112 may be regulated by PID control in other examples to adjust or maintain the measured temperature Tₘ. Moreover, during the first post-heat stage 112 the controller 80 may regulate operation of the duty cycle and the heating elements 40, 50, 60 based on other non-PID methods of control. For instance, the controller 80 may selectively pause and resume operation of the second-stage duty cycle at various times based on PID or hysteresis control to adjust or maintain the measured temperature Tₘ relative to the target temperature T_{y}.

In some examples, the target temperatures Tₓ, T_{y} of the preheat and first post-heat stages 110, 112 can correspond to a desired cooking temperature T_{d} (e.g., 350° F.) that is selected on the user interface 30 and input to the controller 80, such that the preheat stage 110 increases the measured temperature Tₘ up to the desired cooking temperature T_{d} and the first post-heat stage 112 maintains the measured temperature Tₘ about that temperature. In other examples, one or both of the target temperatures Tₓ, T_{y} can be offset from the desired temperature T_{d} by a predetermined offset to account for inaccuracies, inefficiencies, thermal inertias, sensor locations, or other conditions associated with the cooking appliance 10.

For instance, the target temperatures Tₓ, T_{y} in the present example are offset from the desired temperature T_{d} by an additional 5° F. and 15° F., respectively. The target temperature Tₓ of the preheat stage 110 has a smaller offset because that stage is not regulated by PID control and therefore may end with a high thermal inertia that continues to increase cavity temperature after the preheat stage 110 has ceased. Indeed, it is typically preferable for the preheat stage 110 to perform its duty cycle without any PID-based reduction of its durations dxi, dₓ₂, dₓ₃ so that the measured temperature Tₘ rises quickly to the target temperature Tₓ. Nevertheless, the preheat stage 110 in some examples may be PID-controlled and/or have a target temperature Tₓ that is similar or equal to the target temperature T_{y} of the first post-heat stage 112.

As discussed above, the preheat and first post-heat stages 110, 112 will both perform duty cycles that sequentially energize the heating elements 40, 50, 60. Moreover, the duty cycles of the preheat and first post-heat stages 110, 112 will likewise sequentially deenergize the heating 40, 50, 60, one after another. In the present embodiment, no two elements are active at the same time. However, in other embodiments, the heating elements 40, 50, 60 may be sequentially energized and deenergized such that there is a period of overlap during which two heating elements are both active. For instance, sequentially energized and deenergized heating elements can overlap by energizing a first element for a period of time, energizing a second element while the first element is still active, and then deenergizing the first element before the second element is deenergized.

By sequentially energizing and deenergizing the heating elements 40, 50, 60 while the food item 90 is stationary and located within the oven cavity 18, both the preheat and first post-heat stages 110, 112 will provide a rotating cycle of heat about the food item 90 that periodically and sequentially exposes its sides to direct radiation from an active heating element, thereby simulating rotisserie cooking without having to rotate the food item 90. For example, the duty cycle of each stage will initially energize the bake element 40 to generate radiation for a bottom side of the food item 90, followed by the broil element 50 to generate radiation for a top side of the food item 90, and followed by the convection element 60 to generate radiation for a rear side of the food item 90. The duty cycle of each stage will also de-energize the bake element 40 first, followed by the broil element 50, and followed by the convection element 60. Moreover, the duty cycle of each stage can activate the convection fan 64 for the entire duration of its duty period to circulate heated air within the cavity 18 and assist with cooking the front side of the food item 90. The duty cycle of each stage 112, 114 will repeat itself for the remainder of the stage, thereby simulating rotisserie cooking for the food item 90 without having to implement a motor and rotating skewer that rotate the food item 90.

In some examples, the first post-heat stage 112 can continue performing and regulating its duty cycle as discussed above indefinitely, thereby maintaining the measured temperature Tₘ about the target temperature T_{y} until a user ceases the cooking operation 100. However, in the present embodiment, the first post-heat stage 112 will perform and regulate its duty cycle for a predetermined amount of time Y, at which point the first post-heat stage 112 will cease and the second post-heat stage 114 will commence.

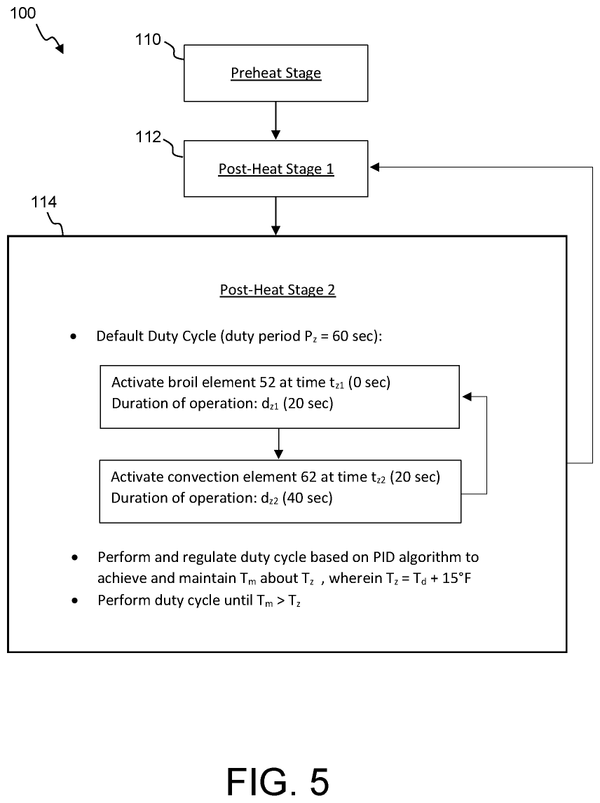

During the illustrated second post-heat stage 114, the controller 80 will operate only heating elements 50, 60 according to a predetermined duty cycle that sequentially energizes and deenergizes those elements similarly as discussed above. In particular, the second post-heat stage 114 has a predetermined duty cycle (see FIG. 5) with a duty period P_{z} of 60 seconds. During that duty cycle the controller 80 will energize the broil element 50 at time t_{z1} (0 seconds) for a duration d_{z1} (20 seconds), and thereafter will energize the convection element 60 at time t_{z2} (20 seconds) for a duration d_{z2} (40 seconds). Similar to the first post-heat stage 112 discussed above, these initial settings of the duty cycle for the second post-heat stage 114 are considered its default settings. The second post-heat stage 114 will repeat this duty cycle in order to increase the temperature Tₘ measured by the sensor 82 to a predetermined target temperature T_{z} of the second post-heat stage 114.

Moreover, similar to the first post-heat stage 112, the heating elements may be sequentially energized and deenergized with or without intermediate overlap. Also similar to the first post-heat stage 112, during the second post-heat stage 114 the controller 80 can regulate the parameters of its duty cycle (and thus operation of the heating elements 50, 60) based on a PID algorithm that compares the measured temperature Tₘ to the target temperature T_{z}. For instance, the second post-heat stage 114 can similarly regulate the durations d_{z1}, d_{z2} of the duty cycle as a product of their default settings and a gain determined by the PID algorithm. However, the second post-heat stage 114 may regulate operation of its duty cycle based on other non-PID methods of control. For instance, the second post-heat stage 114 may simply operate its duty cycle without adjustment until the measured temperature Tₘ reaches target temperature T_{z}.

The second post-heat stage 114 is similarly configured to simulate rotisserie cooking by sequentially activating the broil and convection elements 50, 60 during its duty cycle to provide a rotating cycle of heat about the food item 90 that periodically and sequentially exposes top and rear sides of the food item 90 to direct radiation. Moreover, the duty cycle of the second post-heat stage 114 can similarly activate the convection fan 64 during its entire duty period P_{z} to assist with cooking the front and lower sides of the food item 90.

The second post-heat stage 114 is particularly configured to mimic the effects of flames on a grill rotisserie by quickly increasing the oven cavity temperature to increase browning and outer crust formation of the food product 90. In particular, the target temperature T_{z} of the second post-heat stage 114 is offset from the desired cooking temperature T_{d} by an additional 65° F., which is 50° F. higher than the target temperature T_{y} of the first post-heat stage 112. However, in other examples, the target temperature T_{z} may be a fixed temperature that is not a function of the desired cooking temperature T_{d}. The target temperature T_{z} of the second post-heat stage 114 can be any fixed or variable temperature that is higher than the target temperature T_{y} of the first post-heat stage 112. Preferably, the target temperature T_{z} will be at least 390° F., and more preferably at least 400° F. Moreover, the target temperature T_{z} will preferably be at least 40° F. higher than the target temperature T_{y} of the first post-heat stage 112, and more preferably at least 50° F. higher than the target temperature T_{y} of the first post-heat stage 112.

Furthermore, in the preferred cooking appliance 10, the broil and convection elements 50, 60 are significantly more powerful than the bake element 40 and therefore are the only elements utilized to quickly heat the oven cavity 18 during the second post-heat stage 114. However, this may vary in other embodiments. For instance, in some examples, the bake and broil elements 40, 50 may be more powerful than the convection element 60 and therefore may be the only elements utilized to the heat the oven cavity 18. Generally speaking, the second post-heat stage 114 may utilize any number and combination of the heating elements 40, 50, 60 to increase oven cavity temperature up to the target temperature T_{z}.

The second post-heat stage 114 will continue performing and adjusting its duty cycle as discussed above until the measured temperature Tₘ exceeds the target temperature T_{z}, at which point the second post-heat stage 114 will cease and the first post-heat stage 112 will recommence. The cooking operation 100 will continue to repeatedly perform the first and second post-heat stages 112, 114 in alternating manner until a user ceases the cooking operation 100 via the user interface 30, or alternatively until the expiration of a pre-programmed or user-selected cook time.

The controller 80 of the cooking appliance is programmed to perform the cooking operation 100 described above by operating to the heating elements 40, 50, 60 accordingly. In particular, the predetermined duty cycles, desired cooking temperature, target temperatures, temperature offsets, and control algorithms of the operation 100 can be programmed into and stored in the controller 80. Moreover, a user can enter a start command for the cooking operation 100 via the user interface 80, which will send a corresponding start signal to the controller 80. In response to that signal, the controller 80 will operate the heating elements 40, 50, 60 to perform the cooking operation 100 in the manner described above.

Although the hereinabove described embodiments of the invention constitute preferred embodiments, it should be understood that modifications can be made thereto without departing from the spirit and the scope of the invention as set forth in the appended claims. For example, the settings (e.g., duty periods, on times, durations, offsets, desired cooking temperature) and algorithms of the stages 112, 114, 116 described above are merely exemplary and could vary by embodiment. Moreover, the cooking operation 100 may comprise fewer or more stages than those described above. In one example, the cooking operation 100 may simply comprise the first post-heat stage 114. Still further, each stage of the cooking operation 100 may operate additional or fewer heating elements than those described above. Broadly speaking, the cooking operation 100 can comprise any number of stages that sequentially energize two or more heating elements.

What we claim is:

1. A method for cooking a food item in an oven cavity of a cooking appliance, the cooking appliance including a first heating element and a second heating element spaced about the oven cavity, the method comprising:
a first stage in which the first heating element and the second heating element are sequentially energized according to a first duty cycle in which the first heating element is energized at a first time for a first duration and the second heating element is energized at a second time for a second duration,
wherein the first duration and the second duration are regulated based on a measured temperature and a first predetermined target temperature.

2. The method according to claim 1, wherein the first stage provides a rotating cycle of heat about the food item.

3. The method according to claim 1, wherein during the first stage the first heating element and the second heating element are operated according to the first duty cycle for a predetermined amount of time.

4. The method according to claim 1, wherein during the first stage, the first heating element and the second heating element are operated according to the first duty cycle until the measured temperature exceeds the first predetermined target temperature.

5. The method according to claim 1, further comprising the step of receiving a selection of a desired temperature on a user interface of the cooking appliance, wherein the predetermined target temperature is offset from the desired temperature by a predetermined offset.

6. The method according to claim 5, wherein the first duration and the second duration of the first duty cycle are regulated based on a PID algorithm that compares the measured temperature to the first predetermined target temperature.

7. The method according to claim 1, wherein:
the cooking appliance further includes a third heating element,
the first duty cycle energizes the third heating element at a third time in the first duty cycle for a third duration, and
the third duration of the first duty cycle is regulated based on the measured temperature and the first predetermined target temperature.

8. The method according to claim 1, further comprising a second stage in which the first heating element and the second heating element are sequentially energized according to a second duty cycle,
wherein during the first stage, the first duration and the second duration of the first duty cycle are regulated in order to maintain the measured temperature relative to the first predetermined target temperature, and
wherein during the second stage, the first heating element and the second heating element are operated according to the second duty cycle until the measured temperature exceeds a second predetermined target temperature that is greater than the first predetermined temperature.

9. The method according to claim 8, wherein the second predetermined target temperature is at least 40° F. greater than the first predetermined target temperature.

10. The method according to claim 1, further comprising a preheat stage before said first stage, wherein during the preheat stage the first heating element and the second heating element are sequentially energized according to a preheat duty cycle until the measured temperature exceeds a predetermined preheat target temperature.

11. A method for cooking a food item in an oven cavity of a cooking appliance, the cooking appliance including a first heating element and a second heating element spaced about the oven cavity, the method comprising:
a first stage in which the first heating element and the second heating element are sequentially energized according to a first duty cycle, wherein operation of the first duty cycle is regulated in order to maintain a measured temperature relative to a first predetermined target temperature; and
a second stage in which the first heating element and the second heating element are sequentially energized according to a second duty cycle until the measured temperature exceeds a second predetermined target temperature that is greater than the first predetermined temperature.

12. The method according to claim 11, wherein the first stage and second stage each provide a rotating cycle of heat about the food item.

13. The method according to claim 11, wherein during the first stage, operation of the first duty cycle is regulated in order to maintain the measured temperature within 15° F. of the first predetermined target temperature.

14. The method according to claim 11, wherein during the first stage, the first heating element and the second heating element are operated according to the first duty cycle for a predetermined amount of time.

15. The method according to claim 11, wherein the first stage and second stage are repeatedly performed in an alternating manner.

16. The method according to claim 11, wherein the second predetermined target temperature is at least 40° F. greater than the first predetermined target temperature.

17. The method according to claim 11, wherein:
the cooking appliance further includes a third heating element,
the first duty cycle sequentially energizes the first heating element, the second heating element, and the third heating element, and
the second duty cycle does not energize the third heating element.

18. The method according to claim 17, wherein:
the first heating element comprises a broil element arranged adjacent to an upper wall of the oven cavity,
the second heating element comprises a convection element arranged adjacent to a rear wall of the oven cavity, and
the third heating element comprises a bake element arranged adjacent to a lower wall of the oven cavity.

19. The method according to claim 11, further comprising a preheat stage before said first stage, wherein during the preheat stage the first heating element and the second heating element are sequentially energized according to a preheat duty cycle until the measured temperature exceeds a preheat target temperature that is predetermined.

20. A method for cooking a food item in an oven cavity of a cooking appliance, the cooking appliance including a first heating element and a second heating element spaced about the oven cavity, the method comprising:
a first stage in which the first heating element and the second heating element are sequentially energized according to a first duty cycle, wherein operation of the first duty cycle is regulated in order to maintain a measured temperature relative to a first predetermined target temperature; and
a second stage in which the first heating element and the second heating element are sequentially energized according to a second duty cycle until the measured temperature exceeds a second predetermined target temperature that is greater than the first predetermined temperature,
wherein the first stage and second stage are repeatedly performed in an alternating manner.
